(19) United States
(12) Patent Application Publication
(10) Pub. No.: US 2025/0033135 A1
(43) Pub. Date: Jan. 30, 2025

(54) ELECTRODE ARRANGEMENT AND WELDING CLAMP ARRANGEMENT

(71) Applicant: STÄUBLI ELECTRICAL CONNECTORS AG, Allschwil (CH)

(72) Inventors: Sébastien ENDERLIN, Moeranch (FR); Richard GNODTKE, Huningue (FR)

(73) Assignee: Stäubli Electrical Connectors AG, Allschwil (CH)

(21) Appl. No.: 18/715,319

(22) PCT Filed: Nov. 28, 2022
(86) PCT No.: PCT/EP2022/083454

§ 371 Date: May 31, 2024

(30) Foreign Application Priority Data
Dec. 1, 2021 (EP) 21211691.7

(51) Int. Cl. B23K 11/30

(52) U.S. Cl. CPC B23K 11/3027

(57) ABSTRACT

An electrode arrangement for a welding clamp arrangement having a first electrode with an electrode shaft extending along an electrode axis, and an electrode tip, and a power supply unit, wherein the power supply unit has a contact bridge and a contact rod extending along a rod axis and having a contact surface. The contact bridge has a contact opening, in which the contact rod is mounted in an axially displaceable manner in a direction of its rod axis, and in an electrically conductive manner, and the contact bridge has a contact region, which is connected to the first electrode in a mechanically fixed and electrically conductive manner.

### TECHNICAL FIELD

The present invention relates to an electrode arrangement for a welding clamp arrangement according to claim 1 and a welding clamp arrangement according to claim 15.

### PRIOR ART

EP 2 758 207 discloses a welding clamp with shunts as power supply elements. Due to the mechanical movement of the welding clamp, such shunts must be designed in a flexible manner. The mechanical loads of these shunts are very high and thus the shunts must also be replaced on a regular basis. Especially in production lines, the replacement must be carried out quickly, in order to minimize the loss of production.

U.S. Pat. No. 4,260,868 discloses a sliding contact for the power supply of the electrode. The sliding contact acts directly upon the electrode. The contact fingers of the sliding contact are directly pressed onto the cylinder of the electrode. A disadvantage of U.S. Pat. No. 4,260,868 is the compact arrangement of the electrode, what renders the replacement of the electrode very cumbersome in case of a defect.

### SUMMARY OF THE INVENTION

Starting from this prior art, the invention is based on the problem of providing an electrode arrangement for a welding clamp arrangement, which is designed in such a manner, that the elements provided for the power supply of the electrode can be replaced in a simple manner in case of a defect.

This problem is solved by the subject matter of claim 1. Thereby, an electrode arrangement comprises a first electrode with an electrode shaft extending along an electrode axis, and with an electrode tip, as well as a power supply unit. The power supply unit comprises a contact bridge and a contact rod extending along a rod axis and having a contact surface. Preferably, the contact bridge comprises a contact opening, in which the contact rod is mounted in an axially displaceable manner in a direction of the rod axis and in an electrically conductive manner. The contact bridge further comprises a contact region, which is arranged in a mechanically fixed manner and is connected in an electrically conductive manner with the first electrode.

As a result of the arrangement of the contact bridge, an offset is created between the contact rod and the first electrode. The offset results in the advantage that more space is created between electrode and contact rod, thus improving the accessibility for maintenance operations. Especially, the contact point which facilitates the axial displaceability lies in an axially offset manner with respect to the electrode, whereby this contact point is more easily accessible.

Furthermore, the electrode the contact bridge the electrode is relieved during the welding process. This especially is an advantage compared to the electrode arrangements in which a contact unit is arranged in a slidable manner on the surface of the electrode shaft.

The electrode axis of the electrode shaft is arranged in a spatially offset manner with respect to the rod axis. This means that the electrode axis is not collinear to the rod axis.

The electrode shaft can be connected to the contact bridge either directly or indirectly via a holding element. The electrode tip is arranged on the free end of the electrode and can be brought into contact with the welding material. Preferably, the electrode tip is mounted in a replaceable manner on the electrode shaft.

In the starting position, the first electrode lies spaced apart from the second electrode. In the welding position, the first electrode comes into contact with the welding material, which lies between the two electrodes, whereby the second electrode also is in contact with the welding material, such that a resistance welding can be provided.

According to a first embodiment of the invention, the first electrode and the contact rod lie parallel and offset to each other, such that the rod axis lies in a parallel offset manner with respect to the electrode axis, wherein the first electrode and the contact rod are displaceable with respect to each other in a direction of the respective axis.

Especially preferably, the first electrode is displaceable in direction of the electrode axis from a starting position into a welding position, wherein the contact rod is arranged in an offset manner with respect to the first electrode, such that the rod axis lies in a parallel offset manner with respect to the electrode axis.

The electrode axis runs in a parallel offset manner to the rod axis. This means that the electrode axis runs spaced apart from the rod axis. The electrode axis and the rod axis do not run collinear to each other.

During the movement of the electrode or of the contact rod, respectively, in direction of the respective axis, the electrode or the contact rod, respectively, is displaced along a linear longitudinal movement. Preferably, the first electrode is displaced in direction of the second electrode, which is arranged in a fixed or likewise displaceable manner. Alternatively, the second electrode can also be displaced towards the first electrode.

The contact surface of the contact rod is preferably a cylindrical surface with a circular cylindrical or a rectangular cross-section. The rod axis therein is defined as a center axis of the cylindrical surface.

In the contact opening, an electrical contact can be provided between the contact rod and the contact bridge. Therein, the electrical contact is maintained during the entire axial movement.

In a first variant, the contact opening is preferably part of a contact ring, which can be inserted into a mounting opening on the contact bridge. This embodiment has the advantage that the contact ring can be replaced in a relatively simple manner in case of a defect or upon excessive wearing of the contact elements.

Preferably, the contact ring is pressed into the mounting opening or is connected to the mounting opening via a threaded connection. Preferably, the contact ring comprises a shoulder which projects radially from an exterior surface, and which provides a stop for the contact ring on the contact bridge.

In one variant, the contact opening is integrally formed into the contact bridge.

Preferably, the contact region is formed as an opening and the first electrode projects with the electrode shaft into the opening. Between the opening and the electrode, an electrical contact is created. Especially preferably, the electrode comprises a thread section and the opening is a thread opening.

Preferably, the power supply unit further comprises a contact lug. The contact rod comprises on one end a contact section, to which the contact lug is connected in an electrically contacting manner.

Preferably, the contact section is provided by a front surface, which is oriented perpendicular to the rod axis. Furthermore, a thread opening extends from the front surface into the contact rod. The contact lug is attached to the contact rod by a screw, which can be screwed into the thread opening.

Preferably, a spring washer is arranged as a screw securing element additionally to the screw. Other screw securing elements are also conceivable.

Preferably, the contact lug is formed as a rigid conductor with a rigid cross-section. Preferably, the contact lug comprises a rectangular cross-section. Preferably, the contact lug comprises an additional contact region, by which the contact lug can be connected to a power supply element, such as to a transformer. Preferably, the contact lug is oriented along a lug axis, said lug axis being oriented perpendicular to the rod axis.

Preferably, the contact rod and/or the first electrode comprises at least two wrench surfaces, which lie opposite each other with respect to the rod axis or the electrode axis, respectively, wherein said wrench surfaces are designed to interact with an open-ended wrench.

Preferably, the contact rod comprises a sliding region with a cylindrical cross-section, wherein the contact bridge can be displaced along the sliding movement from one end of the sliding region to the other end of the sliding region. During the displacement of the contact bridge, the electrode is moved from the starting position into the welding position and from the welding position into the starting position.

The sliding region preferably extends over only a partial length of the contact rod. Preferably, the wrench surfaces are arranged outside of the sliding region.

Preferably, the welding clamp arrangement further comprises a longitudinal guiding, over which the electrode and/or the contract bridge is guided.

In a second embodiment, the contact bridge is formed in a two-part manner comprising a first contact bridge part and a second contact bridge part, wherein the first contact bridge part comprises said contact opening and wherein the second contact bridge part comprises said contact region, wherein the two contact bridge parts are connected to each other in a pivotable manner via a pivot connection about a pivot axis and in an electrically conductive manner, such that the two contact bridge parts are pivotable relative to each other.

As a result of the arrangement of the pivot connection, the second embodiment can be used in an advantageous manner in electrode arrangements in which the electrodes carry out a pivot movement.

Preferably, the pivot connection comprises a pivot trunnion and a pivot opening, wherein the pivot trunnion is arranged in a pivotable manner in the pivot opening and wherein an electrical contact element and/or a plain bearing is arranged between the pivot trunnion and the pivot opening.

Preferably, the electrode is connected directly to the second contact bridge part. Alternatively, the electrode is connected to the second contact bridge part in an indirect manner via an electrode arm.

Preferably, the electrode arm is mounted on a pivot bearing in a pivotable manner about a pivot axis, wherein said pivot axis runs parallel to the pivot axis of the pivot connection.

Preferably, the power supply unit according to the second embodiment furthermore comprises a contact lug and the contact rod comprises on one end a contact section, on which the contact lug is connected in an electrically contacting manner, wherein the contact section preferably is in an electrical contact with the contact lug via a pivot connection, wherein said pivot connection comprises a pivot trunnion and a pivot opening, wherein the pivot trunnion is arranged in the pivot opening in a pivotable manner, and wherein an electrical contact element and/or a plain bearing is arranged between the pivot trunnion and the pivot opening.

In the following, especially preferred elements are described, which can be used in all embodiments:

Preferably, the contact rod comprises a cooling agent channel with a cooling agent inlet and a cooling agent outlet, wherein cooling agent can be guided from the cooling agent inlet through the cooling agent channel to the cooling agent outlet. Thereby, the electrode can be cooled. The cooling agent channel extends essentially over the entire length of the contact rod or at least over the length, by which the contact bridge is displaced with respect to the contact rod.

Preferably, the cooling agent channel is provided by a bore in the contact rod and a sleeve inserted into the bore. Within of the sleeve, a first section of the cooling agent channel is provided, and outside of the sleeve, a second section of the cooling agent channel is provided. The sleeve provides at least one breakthrough, which connects the first section and the second section to each other.

Preferably, at least one contact element is arranged in the contact opening, said contact element comprising a plurality of spring-mounted contact parts. The spring-mounted contact parts are pressed in a spring-loaded manner against the contact surface, such that an electrical contact is created between the contact surface and the interior surface of the contact opening via the contact parts.

Preferably, two or more contact elements are arranged in an offset manner to each other with respect to the rod axis.

The spring-mounted contact parts have the advantage, that good sliding characteristics and a good, especially a determined, electrical contact can be created.

Preferably, the first electrode with the contact bridge is displaced with respect to the fixed contact rod. In other words, the contact rod is preferably arranged in a stationary manner and the contact bridge is arranged with the electrode in a displaceable manner with respect to the contact rod.

Preferably, a plain bearing, which provides a slide mounting for the contact rod, is arranged in the contact opening. Preferably, the plain bearing is a sliding ring, which is arranged in a groove in the contact opening.

A welding clamp arrangement comprises an electrode arrangement according to the above description and a second electrode, wherein the second electrode is arranged in a fixed or displaceable manner with respect to the first electrode, and wherein the first electrode is displaceable in the direction of the second electrode during the movement from the starting position into the welding position.

Further embodiments are laid down in the dependent claims.

### BRIEF DESCRIPTION OF THE DRAWINGS

Preferred embodiments of the invention are described in the following with reference to the drawings, which are for illustrating purposes only and not for limiting purposes. In the drawings,

FIG. 1 shows a lateral view of a welding clamp arrangement according to a first embodiment of the present invention, wherein a first electrode is arranged in a starting position;

FIG. 2 shows the lateral view according to FIG. 1, wherein the first electrode is arranged between the starting position and a welding position;

FIG. 3 shows the lateral view according to FIG. 1, wherein the first electrode is in the welding position;

FIG. 4 shows a perspective view of an electrode arrangement for a welding clamp arrangement, especially for the welding clamp arrangement according to FIGS. 1 to 3;

FIG. 5 shows a sectional illustration of the electrode arrangement according to FIG. 4;

FIG. 6 shows a sectional illustration of a further embodiment of the electrode arrangement according to one of FIGS. 4 and 5 with a cooling channel;

FIG. 7 shows a lateral view of a welding clamp arrangement according to a second embodiment of the present invention, wherein a first electrode is in a starting position;

FIG. 8 shows the lateral view according to FIG. 7, wherein the first electrode is between the starting position and a welding position;

FIG. 9 shows the lateral view according to FIG. 7, wherein the first electrode is in the welding position;

FIG. 10 shows a front view of the welding clamp arrangement according to FIG. 9;

FIG. 11 shows a perspective view of an electrode arrangement for a welding clamp arrangement, especially for the welding clamp arrangement according to FIGS. 7 to 10;

FIG. 12 shows a sectional illustration of the electrode arrangement according to FIG. 10; and

FIG. 13 shows a sectional illustration of partial regions of the first and the second embodiment.

### DESCRIPTION OF PREFERRED EMBODIMENTS

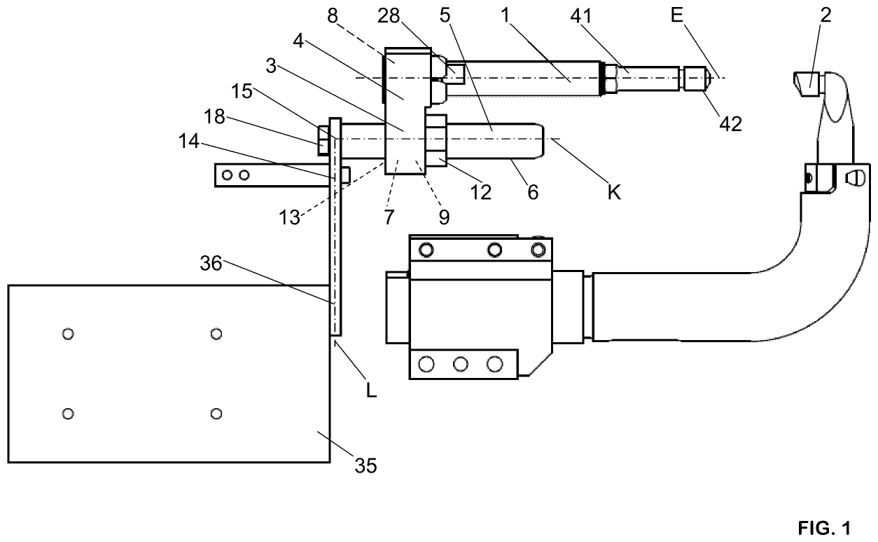

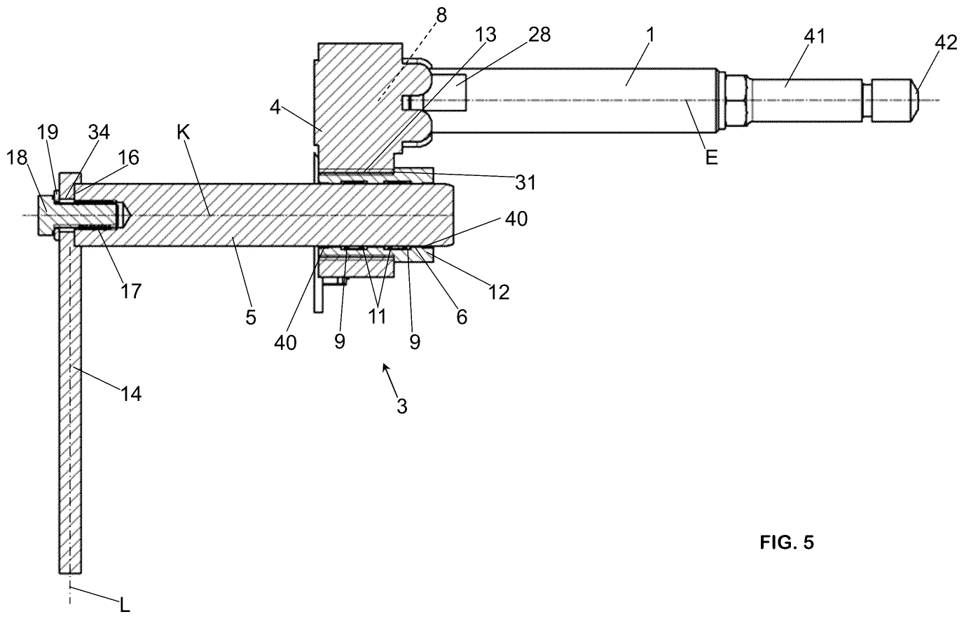

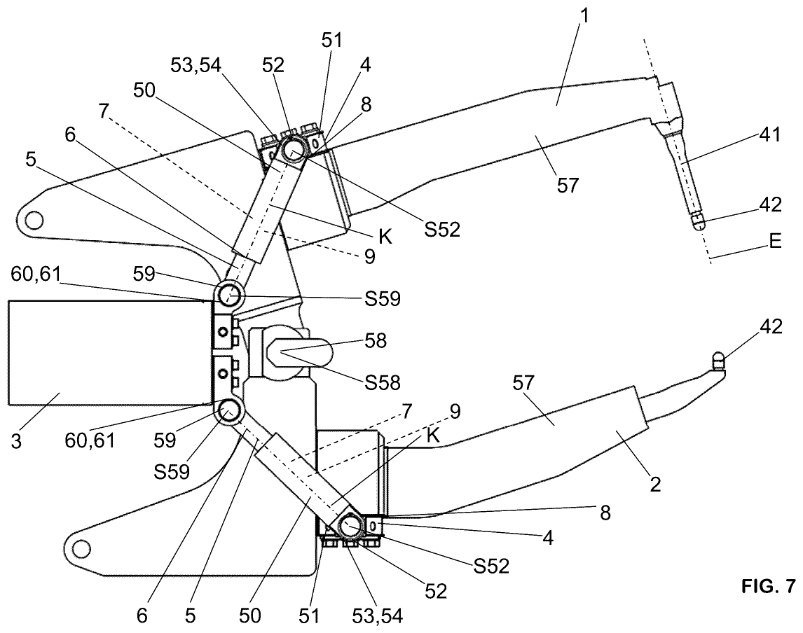

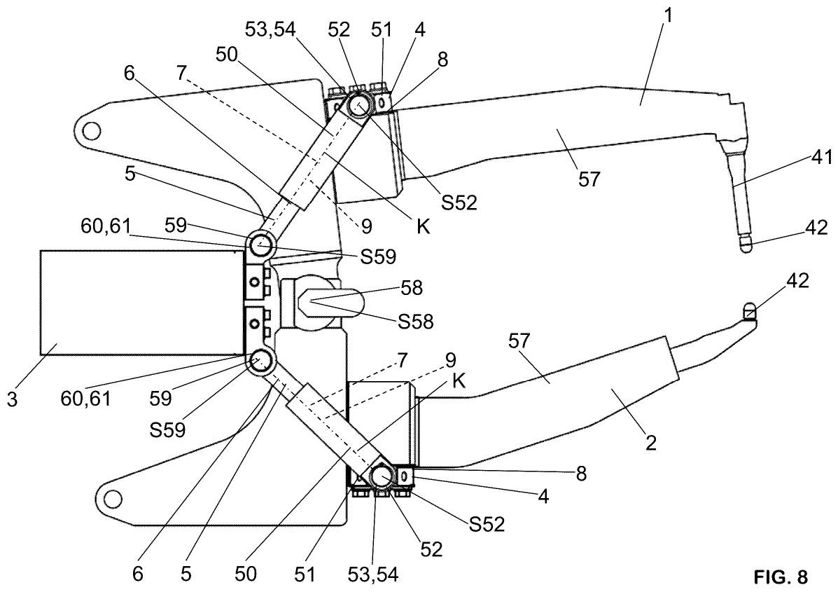

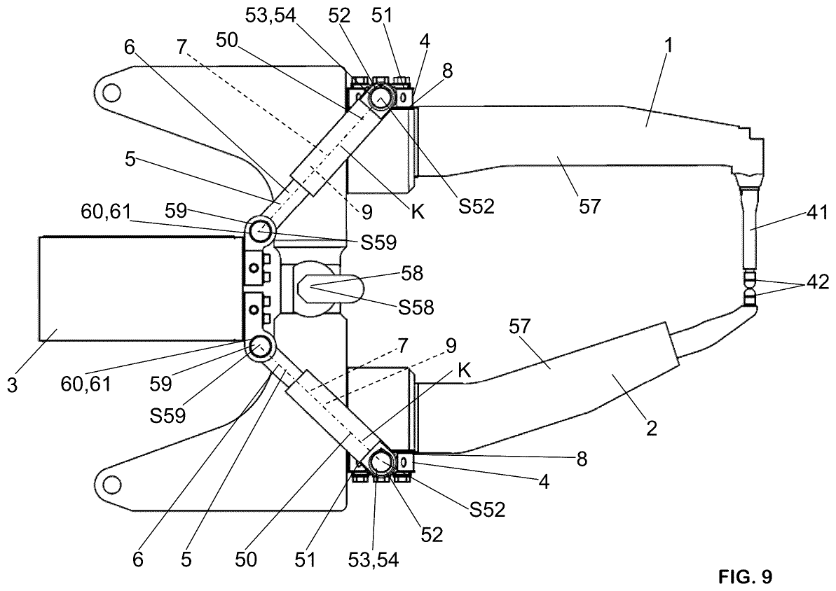

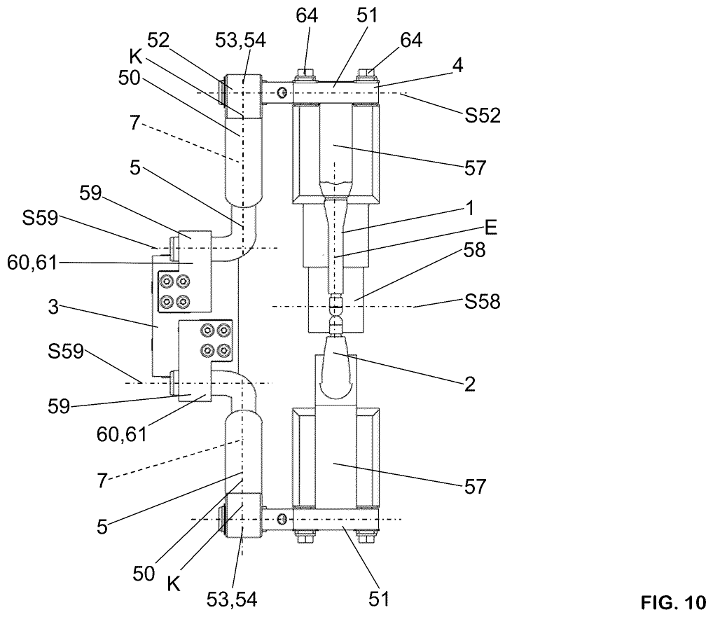

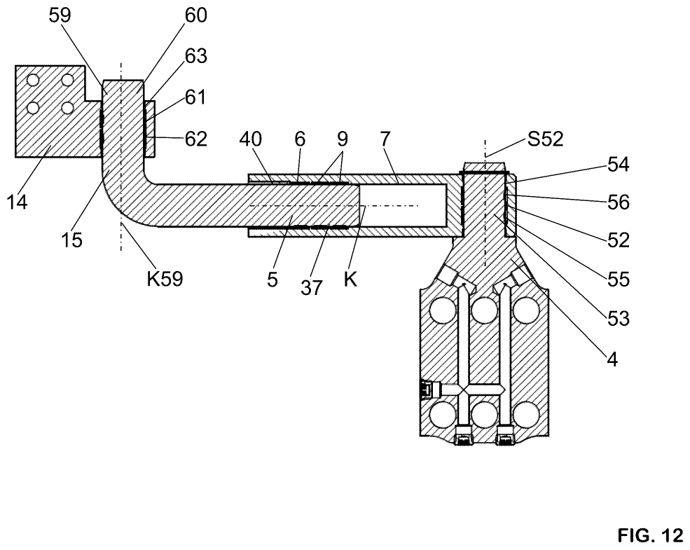

In FIGS. 1 to 6, a first embodiment of a welding clamp arrangement or of an electrode arrangement, respectively, is shown, and in FIGS. 7 to 12, a second embodiment of a welding clamp arrangement or of an electrode arrangement, respectively, is shown.

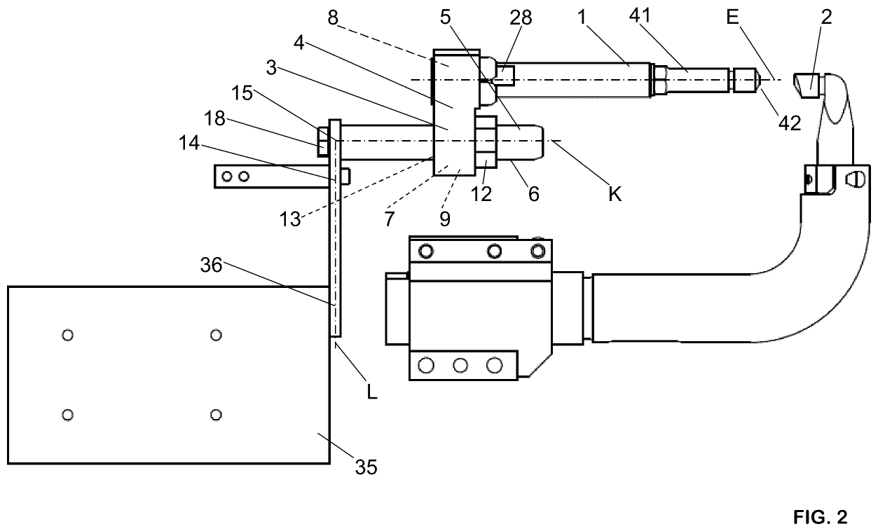

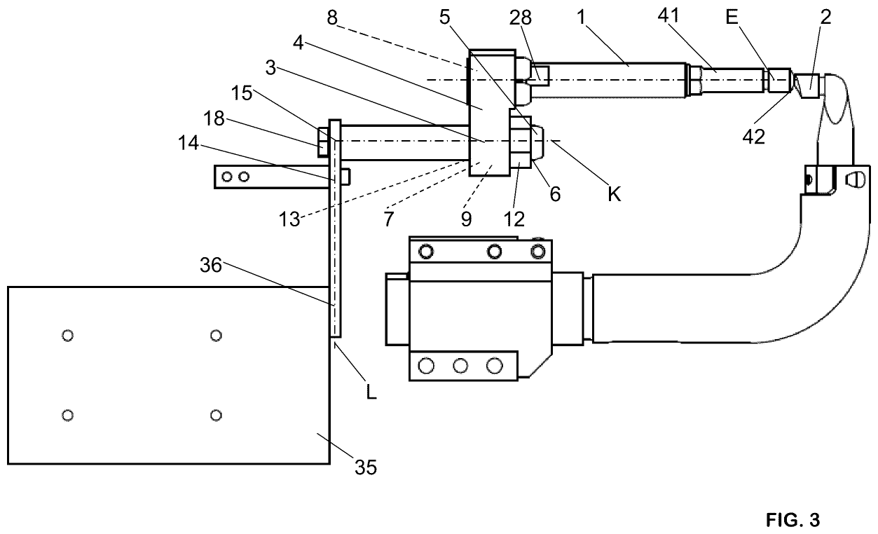

In FIGS. 1 to 3, a welding clamp arrangement is shown. The welding clamp arrangement comprises an electrode arrangement S for supplying the welding clamp arrangement with electric energy, a first electrode 1, and a second electrode 2. Therein, the electrode arrangement S is arranged such that the first electrode 1 is supplied with electric energy. This means that the electrode arrangement S is connected to the first electrode 1 in an electrically conductive manner. In the illustrated embodiment, the first electrode 1 is displaceable from a starting position, as shown in FIG. 1, into a welding position, as shown in FIG. 3. FIG. 2 shows an intermediate position between the starting position and the welding position. In the welding position, the first electrode 1, is in an electrical contact with the second electrode via a welding material not illustrated, and the welding material can be welded accordingly. After the welding has been completed, the first electrode 1 moves from the welding position back into the starting position or back into an intermediate position between the welding position and the starting position.

In the embodiment shown, the second electrode 2 is arranged in a fixed manner with respect to the first electrode 1. The second electrode 2, however, can also be arranged in a displaceable manner with respect to the first electrode 1. The first electrode 1 is displaceable along an electrode axis E in a direction of the second electrode 2. Accordingly, the first electrode 1 is displaced along a longitudinal direction. In other words, the electrodes 1, 2 are displaced according to the first embodiment in dependency of their own displaceability along a longitudinal axis or a longitudinal direction, respectively.

The two electrodes 1, 2 comprise electrode tips designed according to the requirements of the welding to be carried out.

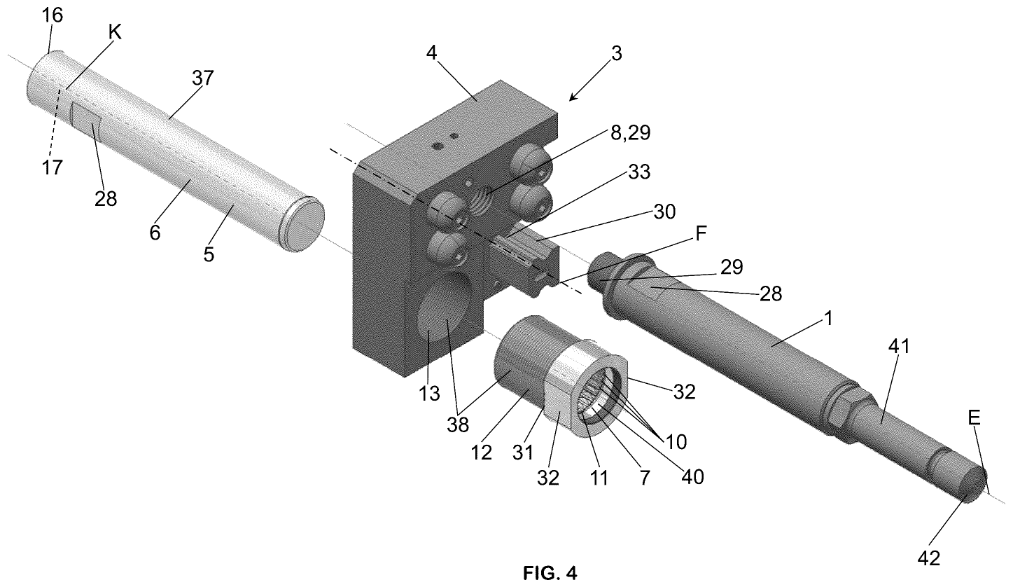

In FIG. 4, the electrode arrangement S is shown in a more detailed manner. The electrode arrangement S for the above mentioned welding clamp arrangement comprises the first electrode 1 and a power supply unit 3. The first electrode 1 is displaceable, as mentioned, in a direction of an electrode axis E from a starting position into a welding position.

The power supply unit 3 comprises a contact bridge 4 and a contact rod 5 which extends along a rod axis K. The contact rod 5 comprises a contact surface 6. The contact bridge 4 comprises a contact opening 7, in which the contact rod 5 is mounted in a displaceable and electrically conductive manner. The axial movement is carried out in a direction of the rod axis K. The contact bridge 4 can be supplied with electric energy via the electrically conductive connection between the contact rod 5 and the contact bridge 4.

Furthermore, the contact bridge 4 comprises a contact region 8. Via this contact region, the first electrode 1 is connected to the contact bridge 4 in a mechanically fixed and electrically conductive manner. Thus, the first electrode 1 is supplied with electric energy via the contact bridge 4.

The contact rod 5 is arranged in an offset manner with respect to the first electrode 1. Therein, the rod axis K lies in an offset manner parallel to the electrode axis E. Thus, the connecting point between the contact rod 5 and the contact bridge 4, and the connecting point between the first electrode 1 and the contact bridge 4 lie in a spaced apart manner to each other. Due to this spatial distance, the two connecting points are more easily accessible, which is an advantage during maintenance operations. The accessibility of the connecting points is generally improved, which simplifies the maintenance operations.

In the illustrated embodiment, the contact opening 7 is part of a contact ring 12, which is insertable into a mounting opening 13 on the contact bridge 4. The contact ring 12 and the mounting opening 13 therein comprise threaded structures 38, such that the contact ring 12 can be screwed into the mounting opening 13. In another embodiment which is not illustrated, it is also conceivable that the contact ring 12 is pressed into the mounting opening 13.

In another, not illustrated embodiment, it is also conceivable that the contact opening 7 is formed directly into the contact bridge 4.

Preferably, at least one contact element 9 is arranged in the contact opening 7. The contact element 9 provides an electrical contact between the contact surface 6 of the contact rod 5 and the interior surface 11 of the contact opening 7. The contact element 9 preferably comprises a plurality of spring-mounted contact parts 10, which are pressed against the contact surface 6 in a spring-loaded manner, such that said electrical contact can be established via the contact parts 10. In the illustrated embodiment, two contact elements 9 are arranged in a spaced-apart manner to each other in a direction of the rod axis K.

Preferably, at least one plain bearing 40 is furthermore arranged in the contact opening 9. Especially preferably, at least two plain bearings 40 are arranged. The plain bearings 40 are for example sliding rings, which are mounted in a groove in the contact opening 9.

In the illustrated embodiment, the contact ring 12 comprises a shoulder 31, which abuts on a corresponding surface on the contact bridge 4. Furthermore, the contact ring 12 comprises two wrench flats 32. Via these wrench flats 32, the contact ring 12 can be actuated by means of a tool, such as an open-ended wrench, during the assembly or the disassembly, respectively.

The contact rod 5 comprises a sliding region 37. The region 37 comprises a circular cylindrical cross-section. Therein, the contact bridge 4 is displaceable in a direction of the rod axis K from one end of the sliding region 37 to the other end of the sliding region 37. The length of the sliding region 37 essentially corresponds to the length of the movement of the first electrode 1 from the starting position into the welding position.

The contact region 8, via which the first electrode 1 is in connection with the contact bridge 4, is arranged as an opening in the illustrated embodiment. The electrode projects into this opening. In the illustrated embodiment, the opening, as well as the electrode 1, comprise threaded structures 29, such that the electrode 1 can be screwed into the opening. In the illustrated embodiment, the first electrode 1 comprises wrench flats 28, which are arranged opposite each other with respect to the electrode axis E. Via these wrench flats 28, the first electrode 1 can be actuated by means of a tool, such as an open-ended wrench, during the assembly or the disassembly, respectively.

In other embodiments, it however is also conceivable that the first electrode 1 is pressed into the opening.

In the illustrated embodiment, the first electrode 1, as mentioned, is connected in an electrically conductive and mechanically fixed manner to the contact bridge 4. The first electrode 1 thus is displaced with the contact bridge 4 with respect to the fixed contact rod 5.

From FIG. 4, it is also perceivable that the contact bridge 4 is mounted on a longitudinal guiding 30 in a displaceable manner along a longitudinal direction. Therein, the longitudinal guiding 30 comprises a guide axis F, which is oriented parallel to the electrode axis E as well as to the rod axis K. The contact bridge 4 comprises a guide reception 33, into which the longitudinal guiding 30 engages accordingly. Preferably, the guide reception 33 and/or the longitudinal guiding 30 is designed in an electrically conductive manner, such that the contact bridge 4 is electrically isolated from the elements, on which the longitudinal guiding 30 is arranged. Alternatively, the longitudinal guiding 30 can also be attached to an element, which is formed in an electrically isolated manner.

Preferably, the guide axis F, the rod axis K, and the electrode axis E lie, in the cross-section, when viewed perpendicular to the respective axes, on corner points of a triangle. I.e. said axes do not lie in a common plane. This results in a compact design.

Furthermore, it can be seen from FIGS. 1 to 3 and 5 to 6, that the power supply unit 3 furthermore comprises a contact lug 14. The contact lug 14 can for example be connected to a power supply element 35 which provides the electric energy. The contact lug 14 is connected to the contact rod 5 in an electrically conductive manner and supplies it with electric energy. The contact rod 5 comprises on one end a contact section 15, via which the contact lug 14 is connected to the contact rod 5 in an electrically contacting manner.

In the illustrated embodiment, the contact section 15 is provided by a front surface 16, which is oriented perpendicular to the rod axis K. A thread opening 17 extends from the front surface 16 into the contact rod 5. The contact lug 14 is attached to the contact rod 5 by a screw 18, which can be screwed into the thread opening 17. The contact lug 14 comprises an opening 34, through which the screw 18 can be guided. In the illustrated embodiment, furthermore, a spring disc 19 is arranged for the purpose of mechanically securing the screw 18.

The contact lug 14 is preferably formed as a rigid conductor with a rigid cross-section. The contact lug 14 can also be described as a power rail. In the illustrated embodiment, the contact lug 14 comprises a rectangular cross-section. The contact lug 14 comprises a further contact region 36, by which the contact lug 14 is connected to a power supply element 35 in an electrically conductive manner. In the illustrated embodiment, the contact lug 14 is oriented along a lug axis L perpendicular, i.e. at right angles, to the rod axis K.

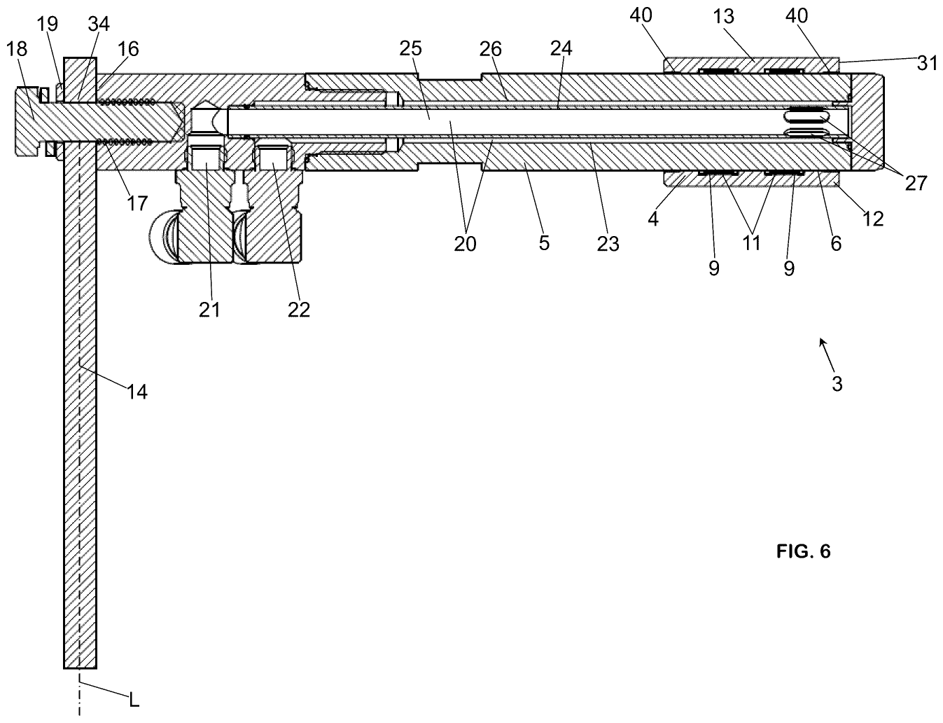

In FIG. 6, a further embodiment of the contact rod 5 is shown. This further embodiment comprises an optional cooling agent channel 20. The cooling agent channel 20 comprises a cooling agent inlet 21 and a cooling agent outlet 22. Via the cooling agent inlet 21, the cooling agent channel 20 can be supplied with a cooling agent, such that the electrode can be cooled. The cooling agent then flows through the cooling agent channel 20 and exits the same through the cooling agent outlet 22.

The cooling agent channel 20 is provided by a bore 23 in the contact rod 5 and a sleeve 24 which is inserted into the bore 23. Within the sleeve 24, a first section 25 of the cooling agent channel is provided. Outside of the sleeve 24, a second section 26 of the cooling agent channel 20 is provided. Furthermore, the sleeve 24 comprises at least one breakthrough 27, which connects the first section 25 of the cooling agent channel 20 to the second section 26 of the cooling agent channel 20. The cooling agent channel 20 preferably extends at least over the length of the contact rod 5, by which the contact bridge 4 is displaced. In other words, the cooling agent channel 20 extends at least over the length of the sliding region 37.

As mentioned, the contact rod 5 can also be formed without a cooling agent channel.

In FIGS. 7 to 12, a second embodiment of the present invention is shown. Same parts are provided with same reference numerals. In the second embodiment, the electrodes 1, 2 or one of the electrodes 1, 2 are/is pivoted via a pivot movement from the starting position into the welding position.

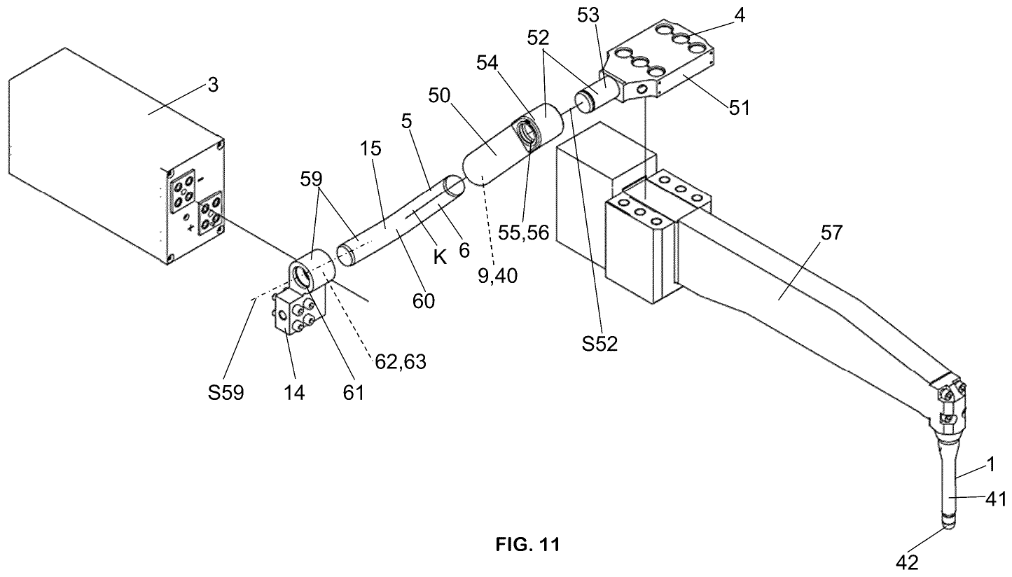

According to the second embodiment, the contact bridge 4 is formed in a two-part manner with a first contact bridge part 50 and a second contact bridge part 51. The first contact bridge part 50 comprises said contact opening 7 and the second contact bridge part 51 comprises said contact region 8. In FIG. 11, it is illustrated that the two contact bridge parts 50, 51 are connected to each other in a pivotable manner about a pivot axis S52 via a pivot connection 52 and in an electrically conductive manner, such that the two contact bridge parts 50, 51 are pivotable with respect to each other.

In the illustrated embodiment, the electrode is connected to the second contact bridge part 51 via an electrode arm 57. Here, the second contact bridge part 51 is connected to the electrode arm 57 in an electrically conductive manner. In the illustrated embodiment, the second contact bridge part 51 is connected to the electrode arm 57 in an electrically conductive manner by screws 64. On one end of the electrode arm, the first electrode 1 with the electrode shaft 41 and the electrode tip 42 is arranged. The electrode arm 57 is mounted on a pivot bearing 58 in a pivotable manner about a pivot axis S58, wherein said pivot axis S58 runs parallel to the pivot axis S52 of the pivot connection 52.

The first contact bridge part 50 comprises, as mentioned, the contact opening 7, in which the contact rod 5 is displaceable in a longitudinal direction. During the pivot movement of the electrode arm, the contact rod 5 also pivots together with the contact opening 7 and the second contact bridge part 51, wherein simultaneously, one of the contact rod 5 and the contact opening 7 are moved relative to each other.

The pivot connection 52 comprises a pivot trunnion 53 and a pivot opening 54. The pivot trunnion 53 projects into the pivot opening 54 in a pivotable manner. Preferably, an electrical contact element 55 and/or a plain bearing 56 is arranged between the pivot trunnion 53 and the pivot opening 54. The electrical contact element 55 is preferably formed like the abovementioned electrical contact element 9 between the contact opening 7 and the contact rod 5.

Preferably, the power supply unit 3 according to the second embodiment further comprises a contact lug 14, and the contact rod 5 comprises, on one end a contact region 15, on which the contact lug 14 is connected in an electrically contacting manner, wherein the contact section 15 preferably is in an electrical contact with the contact lug 14 via a pivot connection 59. The pivot connection comprises a pivot trunnion 60 and a pivot opening 61, wherein the pivot trunnion 60 is arranged in the pivot opening 61 in a pivotable manner and wherein an electrical contact element 62 and/or a plain bearing 63 is arranged between the pivot trunnion 60 and the pivot opening 61.

Preferably, the contact rod 5 according to the second embodiment also comprises a cooling agent channel, which essentially is formed like the above-described cooling agent channel.

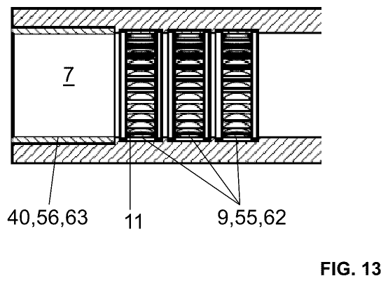

The sectional illustration according to FIG. 13 shows an advantageous arrangement of the at least one contact element 9 between the contact rod 5 and the contact opening 7, or of the at least one contact element 55 between the pivot trunnion 53 and the pivot opening 54, respectively, or of the at least one contact element 62 between the pivot trunnion 60 and the pivot opening 61, respectively.

LIST OF REFERENCE SIGNS

| | |
|---|---|
| 1 | first electrode |
| 2 | second electrode |
| 3 | power supply unit |
| 4 | contact bridge |
| 5 | contact rod |
| 6 | contact surface |
| 7 | contact opening |
| 8 | contact region |
| 9 | contact element |
| 10 | contact parts |
| 11 | interior surface |
| 12 | contact ring |
| 13 | mounting opening |
| 14 | contact lug |
| 15 | contact section |
| 16 | front surface |
| 17 | thread opening |
| 18 | screw |
| 19 | spring disc |
| 20 | cooling agent channel |
| 21 | cooling agent inlet |
| 22 | cooling agent outlet |
| 23 | bore |
| 24 | sleeve |
| 25 | first section |
| 26 | second section |
| 27 | breakthrough |
| 28 | wrench flats |
| 29 | thread structure |
| 30 | longitudinal guiding |
| 31 | shoulder |
| 32 | wrench flats |
| 33 | guide reception |
| 34 | opening |
| 35 | power supply element |
| 36 | further contact region |
| 37 | sliding region |
| 38 | thread structure |
| 40 | plain bearing |
| 41 | electrode shaft |
| 42 | electrode tip |
| 50 | first contact bridge part |
| 51 | second contact bridge part |
| 52 | pivot connection |
| 53 | pivot trunnion |
| 54 | pivot opening |
| 55 | electrical contact element |
| 56 | plain bearing |
| 57 | electrode arm |
| 58 | pivot bearing |
| 59 | pivot connection |
| 60 | pivot trunnion |
| 61 | pivot opening |
| 62 | electrical contact element |
| 63 | plain bearing |
| 64 | screws |
| E | electrode axis |
| F | guide axis |
| K | rod axis |
| L | lug axis |
| S | electrode arrangement |
| S52 | pivot axis |
| S58 | pivot axis |
| S59 | pivot axis |

1-22. (canceled)

23. An electrode arrangement for a welding clamp arrangement, comprising a first electrode with an electrode shaft which extends along an electrode axis and with an electrode tip, and
a power supply unit,
wherein the power supply unit comprises a contact bridge and a contact rod, which extends along a rod axis and which comprises a contact surface,
wherein the contact bridge comprises a contact opening, in which the contact rod is mounted in a direction of its rod axis in an axially displaceable manner and in an electrically conductive manner,
and wherein the contact bridge further comprises a contact region, which is connected to the first electrode in a mechanically fixed and electrically conductive manner.

24. The electrode arrangement according to claim 23, wherein the electrode axis of the electrode shaft is arranged at a spatially offset manner with respect to the rod axis.

25. The electrode arrangement according to claim 23, wherein the first electrode and the contact rod are arranged parallel and offset to each other, such that the rod axis lies parallel offset to the electrode axis, wherein the first electrode and the contact rod are displaceable with respect to each other in a direction of the respective axis.

26. The electrode arrangement according to claim 23, wherein the contact opening is part of a contact ring, which is insertable into a mounting opening on the contact bridge.

27. The electrode arrangement according to claim 23, wherein the contact opening is integrally formed into the contact bridge.

28. The electrode arrangement according to claim 23, wherein the contact region is formed as an opening, wherein the first electrode projects with the electrode shaft into the opening.

29. The electrode arrangement according to claim 23, wherein the power supply unit further comprises a contact lug, and wherein the contact rod comprises on its one end a contact section, on which the contact lug is connected in an electrically contacting manner.

30. The electrode arrangement according to claim 29, wherein the contact section is provided by a front surface, which is oriented perpendicular to the rod axis, wherein a thread opening extends from the front surface into the contact rod and wherein the contact lug is attached to the contact rod by a screw which is screwable into the thread opening.

31. The electrode arrangement according to claim 29, wherein the contact lug is formed as a rigid conductor with a rigid cross-section; and/or
wherein the contact lug comprises a rectangular cross-section; and/or
wherein the contact lug comprises a further contact region, by means of which the contact lug is connectable to a power supply element;
and/or wherein the contact lug extends along a lug axis, wherein said lug axis is oriented perpendicular to the rod axis.

32. The electrode arrangement according to claim 23, wherein the contact rod and/or the first electrode comprises at least two wrench flats which are arranged opposite each other with respect to the rod axis (r the electrode axis, respectively, and which are designed to interact with an open-ended wrench.

33. The electrode arrangement according to claim 23, wherein the welding clamp arrangement further comprises a longitudinal guiding, via which the electrode and/or the contact bridge is guided.

34. The electrode arrangement according to claim 23, wherein the contact bridge is designed in a two-part form comprising a first contact bridge part and a second contact bridge part, wherein the first contact bridge part comprises said contact opening and wherein the second contact bridge part comprises said contact region, wherein the two contact bridge parts are connected in a pivotable manner about a pivot axis via a pivot connection and in an electrically conductive manner, such that the two contact bridge parts are pivotable with respect to each other.

35. The electrode arrangement according to claim 34, wherein the pivot connection comprises a pivot trunnion and a pivot opening, wherein the pivot trunnion is arranged in the pivot opening in a pivotable manner, and wherein an electrical contact element and/or a plain bearing is arranged between the pivot trunnion and the pivot opening.

36. The electrode arrangement according to claim 34, wherein the electrode is in a direct connection with the second contact bridge part; or wherein the electrode is in an indirect connection with the second contact bridge part via an electrode arm.

37. The electrode arrangement according to claim 33, wherein the electrode is in an indirect connection with the second contact bridge part via an electrode arm and wherein the electrode arm is mounted on a pivot mounting in a pivotable manner about a pivot axis, wherein said pivot axis runs parallel to the pivot axis of the pivot connection.

38. The electrode arrangement according to claim 34 wherein the power supply unit further comprises a contact lug, and that the contact rod comprises on its one end a contact section, to which the contact lug is connected in an electrically contacting manner, wherein the contact section preferably is in an electrical contact with the contact lug via a pivot connection, wherein said pivot connection comprises a pivot trunnion and a pivot opening, wherein the pivot trunnion is arranged in the pivot opening in a pivotable manner, and wherein an electrical contact element and/or a plain bearing is arranged between the pivot trunnion and the pivot opening.

39. The electrode arrangement according to claim 23, wherein the contact rod comprises a cooling agent channel with a cooling agent inlet and a cooling agent outlet, wherein cooling agent can be guided from the cooling agent inlet through the cooling agent channel to the cooling agent outlet.

40. The electrode arrangement according to claim 39, wherein the cooling agent channel is provided by a bore in the contact rod and a sleeve inserted into the bore, wherein within the sleeve, a first section of the cooling agent channel is provided, wherein outside of the sleeve, a second section of the cooling agent channel is provided, and wherein the sleeve comprises at least one breakthrough, which connects the first section and the second section to each other.

41. The electrode arrangement according to claim 23, wherein in the contact opening, at least one contact element is arranged for providing an electrical contact between the contact rod and the contact bridge.

42. The electrode arrangement according to claim 41, wherein the contact element comprises a plurality of spring-loaded contact parts, which are pressed against the contact surface in a spring-loaded manner, such that via the contact parts, an electrical contact is established between the contact surface and the interior surface of the contact opening; or that the contact element is formed as a spring, which is arranged within the contact opening.

43. The electrode arrangement according to claim 23, wherein in the contact opening, a plain bearing is arranged, which provides a slide mounting for the contact rod; and/or that the contact rod comprises a sliding region having a cylindrical or rectangular cross-section, wherein the contact bridge is displaceable along the rod axis from one end of the sliding region to the other end of the sliding region.

44. A welding clamp arrangement comprising an electrode arrangement according to claim 23, and a second electrode, wherein the second electrode is arranged in a fixed or displaceable manner with respect to the first electrode, wherein the first electrode is displaceable in a direction of the second electrode during the movement from the starting position into the welding position.
